(19) United States
(12) Patent Application Publication
(10) Pub. No.: US 2026/0340335 A1
(43) Pub. Date: Oct. 29, 2026

(54) MEDIUM MANUFACTURING METHOD AND MEDIUM MANUFACTURING SYSTEM

(71) Applicants: Kazuhiko Kikuchi, Kanagawa (JP); Kiyotaka Murakami, Sunto Shizuoka (JP)

(72) Inventors: Kazuhiko Kikuchi, Kanagawa (JP); Kiyotaka Murakami, Sunto Shizuoka (JP)

(73) Assignee: ETRIA Co., Ltd., Kanagawa (JP)

(21) Appl. No.: 19/452,262

(22) Filed: Jan. 17, 2026

(30) Foreign Application Priority Data
Apr. 23, 2025 (JP) 2025-071301

(51) Int. Cl. G06K 19/077

(52) U.S. Cl. CPC G06K 19/07718; G06K 19/07786

(57) ABSTRACT

According to an embodiment, a medium manufacturing method of manufacturing a medium with a plurality of RFID tags comprises deciding a pasting pitch with which the plurality of RFID tags are pasted at equal intervals to a medium base material cut out in a designated size, supplying, to a pasting position, each RFID tag conveyed from an RFID tag supply roll obtained by holding, in a form of a roll, a base material with a plurality of RFID tags arranged thereon, and conveying the medium base material so that the RFID tag supplied to the pasting position is pasted with the pasting pitch.

### CROSS REFERENCE TO RELATED APPLICATIONS

This application is based upon and claims the benefit of priority from Japanese Patent Application No. 2025-071301, filed Apr. 23, 2025, the entire contents of which are incorporated herein by reference.

### FIELD

Embodiments described herein relate generally to a medium manufacturing method and a medium manufacturing system.

### BACKGROUND

Some image forming apparatuses for forming an image on a medium (sheet) have a function of executing printing on a medium with a plurality of RFID tags and data processing. For example, some digital multi-functional peripherals include an RFID tag reader/writer (to be also referred to as a tag reader/writer (RW) hereinafter) corresponding to an RFID tag, and can write electronic data in an RFID tag of a medium while printing an image on the medium.

Some digital multi-functional peripherals each including the tag reader/writer have a function of performing processing on one medium with a plurality of RFID tags. Conventionally, on a medium that can be processed by the digital multi-functional peripheral including the tag reader/writer, a plurality of RFID tags are arranged at predetermined intervals fixed in advance based on specifications or the like. If the arrangement interval of the plurality of RFID tags on one medium is fixed, control of the pasting position of each RFID tag on a medium base material forming a medium becomes complicated in a manufacturing process of manufacturing a lot of media having the same configuration.

### BRIEF DESCRIPTION OF THE DRAWINGS

FIG. 1 is a view showing an example of the configuration of a medium manufacturing system to which a medium manufacturing method is applied according to an embodiment.

FIG. 2 is a view showing the conveyance state of a medium on which RFID tags pulled out from a tag supply roll are arranged in the medium manufacturing system according to the embodiment.

FIG. 3 is a block diagram showing an example of the configuration of a control system in the medium manufacturing system according to the embodiment.

FIG. 4 is a view showing an example of the arrangement of inlays on a base material pulled out from an inlay supply roll in the medium manufacturing system according to the embodiment.

FIG. 5 is a view showing an example of a medium base material to which a plurality of inlays (RFID tags) are pasted by the medium manufacturing system according to the embodiment.

FIG. 6 is a sectional view showing an example of the configuration of a digital multi-functional peripheral serving as an image forming apparatus having a function of processing a medium manufactured by the medium manufacturing system according to the embodiment.

FIG. 7 is a block diagram for explaining an example of the configuration of a control system in the digital multi-functional peripheral having the function of processing the medium manufactured by the medium manufacturing system according to the embodiment.

FIG. 8 is a view showing a state in which the medium manufactured by the medium manufacturing system is conveyed in the digital multi-functional peripheral according to the embodiment.

FIG. 9 is a flowchart for explaining the procedure of a medium manufacturing method in the medium manufacturing system according to the embodiment.

### DETAILED DESCRIPTION

According to an embodiment, a medium manufacturing method of manufacturing a medium with a plurality of RFID tags comprises deciding a pasting pitch with which the plurality of RFID tags are pasted at equal intervals to a medium base material cut out in a designated size, supplying, to a pasting position, each RFID tag conveyed from an RFID tag supply roll obtained by holding, in a form of a roll, a base material with a plurality of RFID tags arranged thereon, and conveying the medium base material so that the RFID tag supplied to the pasting position is pasted with the pasting pitch.

Embodiments will be described below with reference to the accompanying drawings.

A medium manufacturing system to which a medium manufacturing method is applied according to an embodiment will be described first.

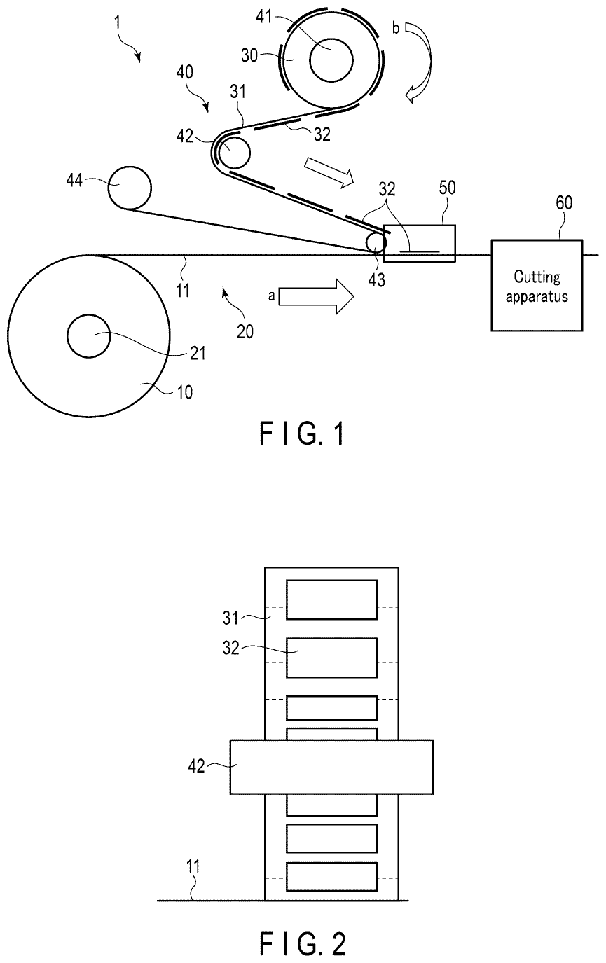

FIG. 1 is a view schematically showing an example of the configuration of a medium manufacturing system 1 to which a medium manufacturing method is applied according to this embodiment. FIG. 2 is a view showing the conveyance state of a base material 31 on which inlays (RFID tags) 32 pulled out from an inlay supply roll (tag supply roll) 30 are arranged in the medium manufacturing system 1 according to the embodiment.

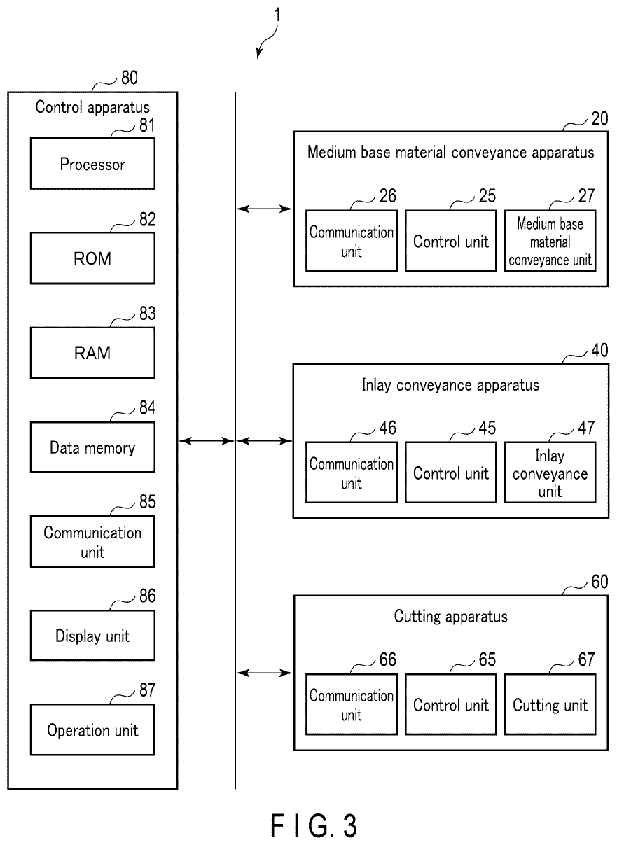

In the example of the configuration shown in FIG. 1, the medium manufacturing system 1 is formed by a medium base material conveyance apparatus 20, an inlay conveyance apparatus 40, a cutting apparatus 60, a control apparatus 80 (see FIG. 3), and the like.

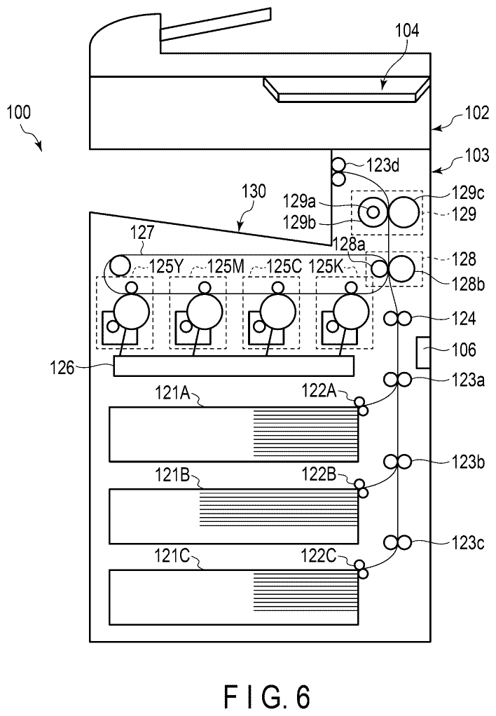

The medium base material conveyance apparatus 20 is a conveyance mechanism that conveys a medium base material 11 pulled out from a medium base material roll 10 obtained by holding, in the form of a roll, a sheet-like paper or resin. The medium base material 11 is a base material that is formed as a medium M with a plurality of RFID tags. The medium M formed from the medium base material 11 is a print medium to be processed by an image forming apparatus such as a digital multi-functional peripheral 100 (to be described later) (see FIG. 6).

The medium base material conveyance apparatus 20 includes a roll shaft 21 on which the medium base material roll 10 is set. The medium base material roll 10 set on the roll shaft 21 rotates about the roll shaft 21 serving as a rotation axis. The medium base material conveyance apparatus 20 pulls out the medium base material 11 from the medium base material roll 10 set on the roll shaft 21. The medium base material 11 pulled out from the medium base material roll 10 is conveyed to the cutting apparatus 60 by a conveyance roller (not shown) and the like. The medium base material 11 passes through the pasting position of an RFID tag (inlay) before the cutting apparatus 60.

The medium base material conveyance apparatus 20 includes a driving mechanism such as a motor that drives the conveyance roller and the like for conveying the medium base material 11, and a control unit that controls the driving mechanism. The control unit of the medium base material conveyance apparatus 20 is communicably connected to the control apparatus 80, and controls the conveyance speed of the medium base material 11 and the like in accordance with a control command from the control apparatus 80.

The inlay conveyance apparatus 40 is a conveyance mechanism that pulls out the sheet-like base material (backing paper) 31 with the RFID tags (to be also referred to as inlays hereinafter) 32 arranged thereon from the inlay supply roll 30 and conveys it. The inlay supply roll 30 is obtained by holding, in the form of a roll, the sheet-like base material (backing paper) 31 on which the inlays (RFID tags) 32 are arranged at predetermined intervals.

This embodiment assumes that the inlay 32 is an RFID tag. The inlay (RFID tag) 32 is an example of an electronic device with a wireless communication function that can be pasted to (or embedded in) a medium on which an image is formed. The inlay 32 is formed by an IC chip (integrated circuit), an antenna, and a substrate. For example, in the inlay 32, the antenna is made of aluminum, silver, copper, or the like, and is adhered to polyethylene terephthalate (PET).

The inlay conveyance apparatus 40 includes a roll shaft 41, a roller 42, a roller 43, and a roller 44. The inlay supply roll 30 is set on the roll shaft 41. The inlay supply roll 30 set on the roll shaft 41 rotates about the roll shaft 41 serving as a rotation axis. The inlay conveyance apparatus 40 pulls out the base material 31 from the inlay supply roll 30 set on the roll shaft 41. The base material 31 pulled out from the inlay supply roll is stretched between the rollers 42 and 43 and is wound by the roller 44.

The inlay conveyance apparatus 40 includes a driving mechanism such as a motor that rotates the roller 44 and the like, and a control unit that controls the driving mechanism. The control unit of the inlay conveyance apparatus 40 is communicably connected to the control apparatus 80, and rotates the roller 44 and the like in accordance with a control command from the control apparatus 80. This causes the inlay conveyance apparatus 40 to convey, at a predetermined conveyance speed, the backing paper 31 with the inlays 32 arranged thereon pulled out from the inlay supply roll.

As shown in FIG. 2, the roller 42 of the inlay conveyance apparatus 40 conveys the base material 31 pulled out from the inlay supply roll 30 while holding the inlays 32 on the base material 31. The inlay conveyance apparatus 40 supplies, to the roller 43, the base material 31 with the inlays 32 arranged thereon pulled out from the inlay supply roll 30. The roller 43 peels off the inlay 32 arranged on the base material 31. A peeling unit that peels off the inlay 32 from the base material 31 may be provided near the roller 43. In addition, the roller 44 recovers the base material 31 from which the inlay 32 is peeled off by the roller 43.

The inlay 32 peeled off from the base material (backing paper) 31 by the roller 43 is supplied to a pasting unit 50 provided at the pasting position to the medium base material 11. The pasting unit 50 pastes, to the medium base material 11 conveyed by the medium base material conveyance apparatus 20, the inlays 32 peeled off from the base material 31 conveyed by the inlay conveyance apparatus 40. The inlays are supplied to the pasting unit 50 at constant intervals corresponding to the conveyance speed of the base material 31 by the inlay conveyance apparatus 40 and the arrangement interval of the inlays 32 on the base material 31.

The pasting unit 50 sequentially pastes, to the medium base material 11 conveyed by the medium base material conveyance apparatus 20, the inlays 32 supplied at the constant intervals. Therefore, the interval between the inlays 32 sequentially pasted to the medium base material 11 is decided based on the arrangement interval of the inlays 32 on the base material 31, the conveyance speed of the medium base material 11 by the medium base material conveyance apparatus 20, and the conveyance speed of the base material 31 by the inlay conveyance apparatus 40. That is, the interval of the inlays 32 sequentially pasted to the medium base material 11 can be adjusted by the relative speed between the conveyance speed of the medium base material 11 by the medium base material conveyance apparatus 20 and the conveyance speed of the base material 31 by the inlay conveyance apparatus 40.

The cutting apparatus 60 cuts the medium base material 11 conveyed by the medium base material conveyance apparatus 20 in a predetermined size (the size of the medium M) for a product. The cutting apparatus 60 is supplied with the medium base material 11, to which the inlays 32 are pasted by the pasting unit 50, at the conveyance speed by the medium base material conveyance apparatus 20. The plurality of inlays 32 are pasted at intervals corresponding to the size of the medium M by setting processing to be described later. Therefore, the cutting apparatus 60 can form the media M of the predetermined size that have the same configuration with respect to the arrangement positions of the plurality of inlays 32 by cutting the medium base material 11 in the predetermined size.

Next, the configuration of a control system in the medium manufacturing system 1 to which the medium manufacturing method is applied according to the embodiment will be described.

FIG. 3 is a block diagram showing an example of the configuration of the control system in the medium manufacturing system 1 according to the embodiment.

As shown in FIG. 3, in the medium manufacturing system 1, the medium base material conveyance apparatus 20, the inlay conveyance apparatus 40, the cutting apparatus 60, the control apparatus 80 (see FIG. 3), and the like are communicably connected to each other.

The control apparatus 80 includes a processor 81, a ROM (Read Only Memory) 82, a RAM (Random Access Memory) 83, a data memory 84, and a communication unit 85. The control apparatus 80 is formed by a computer or the like. In addition, the control apparatus 80 may be a control unit included in the medium base material conveyance apparatus 20, the inlay conveyance apparatus 40, or the cutting apparatus 60.

The processor 81 is connected to the ROM 82, the RAM 83, the data memory 84, the communication unit 85, a display unit 86, an operation unit 87, and the like via a bus line. The bus line includes an address bus, a data bus, and a control signal line. The processor 81 is connected to each unit directly or via a signal input/output circuit through the bus line, and is configured to transmit a mutually exchanged data signal.

The processor 81 is a hardware processor that executes processing of comprehensively controlling the entire medium manufacturing system 1. For example, the processor 81 outputs a control instruction to each apparatus forming the medium manufacturing system 1 in accordance with an operating system or a control program. The processor 81 is, for example, a CPU (Central Processing Unit). The processor 81 may include an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), or an FPGA (Field-Programmable Gate Array).

The ROM 82 is a non-volatile memory. The ROM 82 stores programs to be executed by the processor 81, and various kinds of data.

The RAM 83 is a volatile memory. The RAM 83 is a memory that temporarily holds data. For example, the RAM 83 operates as a memory for deployment, that temporarily stores a program and data when the processor 81 executes the program.

The data memory 84 is a rewritable non-volatile memory. The data memory 84 corresponds to an auxiliary storage unit. The data memory 84 is formed by, for example, an HDD (Hard Disc Drive), an SSD (Solid State Drive), or the like. The data memory 84 stores data to be used by the processor 81 to execute various processes, data created by the processing of the processor 81, and the like. The data memory 84 stores programs to be executed by the processor 81.

The communication unit 85 includes a communication interface for communicating with each apparatus forming the medium manufacturing system 1. For example, the communication unit 85 transmits a control instruction to each apparatus, and receives information from each apparatus. Furthermore, the communication unit 85 may include a communication interface for communicating with an external network or an external apparatus outside the medium manufacturing system 1.

Note that in the control apparatus 80, the processor 81 implements various processing functions (to be described later) by executing programs. The programs executed by the processor 81 are stored (installed) in the non-transitory non-volatile memory such as the ROM 82 or the data memory 84. However, some or all of the various processing functions to be described later may be executed by a hardware circuit provided in the control apparatus 80.

For example, the programs to be installed on the control apparatus 80 may be recorded, as a file in an installable format or executable format, in a computer-readable recording medium such as a CD-ROM, a flexible disk (FD), a CD-R, or a DVD (Digital Versatile Disc), and provided. The programs to be installed on the control apparatus 80 may be stored in a computer connected to a network such as the Internet, and downloaded to the control apparatus 80 via the network. The programs to be installed on the control apparatus 80 may be provided or distributed via a network such as the Internet.

The display unit 86 is formed by a display device that displays information. The display unit 86 is provided at a position where the system administrator or operator of the medium manufacturing system 1 can visually recognize. For example, the display unit 86 displays an operation guidance, the operation state of the medium manufacturing system 1, and the like.

The operation unit 87 is formed by an input device used by the operator to input an operation instruction. The input device serving as the operation unit 87 includes, for example, various input buttons or a touch panel. For example, the display unit 86 and the operation unit 87 may be formed by a display device with a touch panel.

The medium base material conveyance apparatus 20 includes a control unit 25, a communication unit 26, and a medium base material conveyance unit 27.

The control unit 25 controls the medium base material conveyance apparatus 20. The control unit 25 is formed by, for example, a processor, a memory, an interface, and the like. The communication unit 26 includes a communication interface for communicating with the control apparatus 80. For example, the communication unit 26 receives a control instruction from the control apparatus 80, and transmits information indicating a driving state and the like to the control apparatus 80.

The medium base material conveyance unit 27 conveys the medium base material 11. The medium base material conveyance unit 27 drives a driving mechanism such as a motor that drives the roll shaft 21 on which the medium base material roll 10 is set and the conveyance roller for conveying the medium base material 11. The medium base material conveyance unit 27 conveys the medium base material 11 in accordance with a driving command from the control unit 25. The control unit 25 controls conveyance of the medium base material 11 by driving the medium base material conveyance unit 27 in accordance with a control instruction from the control apparatus 80 with which communication is performed by the communication unit 26.

The inlay conveyance apparatus 40 includes a control unit 45, a communication unit 46, and an inlay conveyance unit 47.

The control unit 45 controls the inlay conveyance apparatus 40. The control unit 45 is formed by, for example, a processor, a memory, an interface, and the like. The communication unit 46 includes a communication interface for communicating with the control apparatus 80. The communication unit 46 receives a control instruction from the control apparatus 80, and transmits information indicating a driving state and the like to the control apparatus 80.

The inlay conveyance unit 47 conveys the base material 31 with the inlays 32 arranged thereon. The inlay conveyance unit 47 drives a driving mechanism such as a motor that drives the roll shaft 41 on which the inlay supply roll 30 is set, the roller 44 for winding the base material 31 from which the inlays 32 are peeled off, and the like. The inlay conveyance unit 47 conveys the base material 31 in accordance with a driving command from the control unit 45. The control unit 45 controls conveyance of the base material 31 by driving the inlay conveyance unit 47 in accordance with a control instruction from the control apparatus 80 with which communication is performed by the communication unit 46.

The cutting apparatus 60 includes a control unit 65, a communication unit 66, and a cutting unit 67.

The control unit 65 controls the cutting apparatus 60. The control unit 65 is formed by, for example, a processor, a memory, an interface, and the like. The communication unit 66 includes a communication interface for communicating with the control apparatus 80. For example, the communication unit 66 receives a control instruction from the control apparatus 80, and transmits information indicating a driving state and the like to the control apparatus 80.

The cutting unit 67 cuts the medium base material 11 at a predetermined cutting position. The cutting unit 67 includes a driving mechanism such as a motor that drives a cutter for cutting the medium base material 11 at a cutting position. The cutting unit 67 cuts the medium base material 11 at a timing designated by a driving command from the control unit 65. For example, the cutting unit 67 forms the medium M by cutting the medium base material 11 at a timing corresponding to the conveyance speed of the medium base material 11 and the size of the medium M to be cut out.

Next, the medium M with the plurality of inlays (RFID tags) which is manufactured by the medium manufacturing system 1 according to the embodiment will be described.

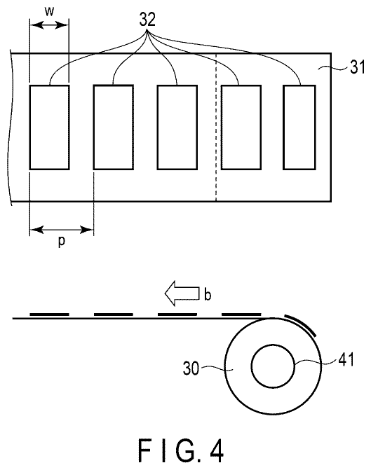

FIG. 4 is a view showing an example of the arrangement of the inlays 32 on the base material 31 pulled out from the inlay supply roll 30 set in the inlay conveyance apparatus 40 of the medium manufacturing system 1 according to the embodiment.

In the example of the arrangement shown in FIG. 4, on the base material (backing paper) 31 pulled out from the inlay supply roll 30, the inlays 32 are arranged at predetermined arrangement intervals with a pitch p. The inlay 32 has a width w in a conveyance direction b of the base material 31, and w<p is satisfied.

Note that the inlay supply roll 30 is provided from, for example, the manufacturer of the inlays 32. In this case, the pitch p and the inlay width w are set in accordance with specifications indicated by the provider of the inlay supply roll 30. With respect to the inlay supply roll 30, when the pitch p of the inlays 32 on the base material 31 is decreased, the base material 31 can be shortened. Thus, the pitch p of the inlays 32 on the base material 31 of the inlay supply roll 30 is designed to be as small as possible without hindering peeling of the inlays 32 and the like.

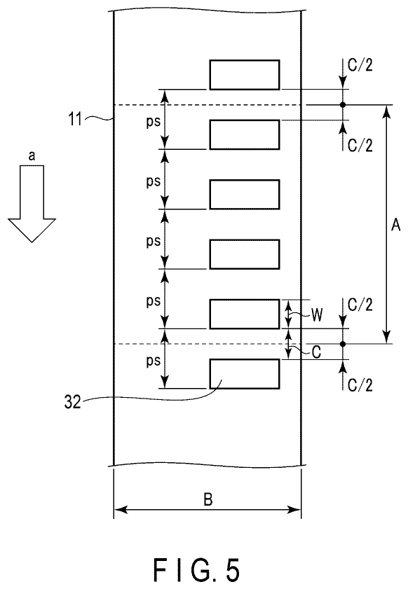

FIG. 5 is a view showing an example of the medium base material 11 to which the plurality of inlays (RFID tags) 32 are pasted by the medium manufacturing system 1 according to the embodiment.

In the example shown in FIG. 5, an example of manufacturing of the medium M of an A×B size (A represents a long side and B represents a short side) on which the four inlays 32 are mounted (pasted).

The medium base material 11 has the width B in a direction orthogonal to a conveyance direction a in which the medium base material 11 is conveyed by the medium base material conveyance apparatus 20. The medium base material 11 is formed in the medium M of the A×B size by being cut by the cutting apparatus 60 to have the length A in the conveyance direction.

The medium manufacturing system 1 according to the embodiment is set so that the inlays 32 are pasted to the medium base material 11 at equal intervals in accordance with the number of inlays (RFID tags) to be arranged on each medium M. That is, the medium manufacturing system 1 is set so that a pasting pitch ps of the inlays 32 on the medium base material 11 is given by ps=A/N where the number of inlays 32 to be arranged on one medium M having a size “A” in the conveyance direction is represented by “N”. Thus, the inlays 32 are pasted to the medium base material 11 at equal intervales with the pasting pitch ps=A/N. Since ps is given by ps=w+C using the width w of the inlay 32 and an interval C between the inlays 32 on the medium base material 11, A=N×(w+C) can be given and C=A/N−w is obtained.

In the example shown in FIG. 5, the four inlays 32 are arranged on one medium M. Therefore, the inlays 32 are pasted to the medium base material 11 at equal intervals so that the pasting pitch ps of the inlays 32 is A/4. In this case, since A=4×(w+C) is obtained, the interval C between the inlays 32 on the medium base material 11 is given by C=A/4−w.

Note that the inlay supply roll 30 is designed so that the pitch p of the inlays 32 on the base material 31 is small. If the pitch p of the inlays 32 on the base material 31 of the inlay supply roll 30 is very small, ps≥p is preferably satisfied to surely control so the inlays 32 do not overlap each other on the medium base material 11. Therefore, the condition that the pasting pitch ps of the inlays 32 on the medium base material 11 satisfies ps≥p may be set.

After pasting the inlays 32 to the medium base material 11 at equal intervals with the pasting pitch ps, the medium manufacturing system 1 cuts the medium base material 11 in the size A of the medium M in the conveyance direction. If the inlays 32 are pasted to the medium base material 11 at equal intervals with the pasting pitch ps, the medium manufacturing system 1 cuts the medium base material 11 in the size A at a predetermined position in the interval C between the inlays 32 on the medium base material 11 in order to cut out the media M with the inlays 32 arranged at the same positions without waste.

For example, if the medium base material 11 is cut at the center (intermediate position) of the interval C between the inlays 32 on the medium base material 11, each cut medium M is formed so that the distance from the leading edge to the inlay (RFID tag) 32 and the trailing edge to the inlay (RFID tag) 32 is constant at C/2. In this case, the medium manufacturing system 1 cuts the medium base material 11, to which the inlays 32 are pasted with the pasting pitch ps and which is conveyed by the medium base material conveyance apparatus 20, at a position of a distance C/2 before the first inlay 32 of each medium M and a position of a distance C/2 after the last (Nth) inlay 32.

In the example shown in FIG. 5, the four inlays 32 are arranged on one medium M. Therefore, the medium manufacturing system 1 controls so that the cutting apparatus 60 cuts the medium base material 11 at positions indicated by dotted lines in FIG. 5. Thus, the medium base material 11 to which the inlays 32 are pasted with the pasting pitch ps and which is conveyed by the medium base material conveyance apparatus 20 is cut at a position of a distance C/2 before the first inlay 32 of each medium M and a position of a distance C/2 after the fourth inlay 32.

As exemplified in FIG. 5, the medium manufacturing system 1 sets the pasting pitch ps of the inlays on the medium base material 11 in accordance with the number of inlays (RFID tags) to be arranged on each medium M. The medium manufacturing system 1 can paste the inlays 32 to the medium base material 11 at equal intervals by controlling driving of the medium base material conveyance apparatus and the inlay conveyance apparatus in accordance with the pasting pitch ps. The medium manufacturing system 1 can manufacture the medium M without useless scraps by pasting the inlays to the medium base material 11 at equal intervals with the pasting pitch ps and then controlling the cutting apparatus to cut the medium base material 11 at the center position of the pasting pitch ps.

Next, an example of an image forming apparatus that executes image formation (printing) and read and write of data on the medium M with the plurality of RFID tags manufactured by the medium manufacturing system 1 according to the embodiment will be described.

FIG. 6 is a sectional view showing an example of the configuration of a digital multi-functional peripheral (MFP) 100 serving as an image forming apparatus having a function of processing the medium M manufactured by the medium manufacturing system 1 according to the embodiment.

As shown in FIG. 6, the digital multi-functional peripheral 100 includes a scanner 102, a printer 103, an operation panel 104, and a tag reader/writer 106.

The scanner 102 is installed in the upper portion of the main body of the digital multi-functional peripheral 100. The scanner 102 is a device that optically reads an image of an original. The scanner 102 includes an original platen glass on which an original to be scanned is placed. The scanner 102 includes an image reading mechanism for scanning an original on the original platen glass. The image reading mechanism of the scanner 102 is formed by a carriage and a photoelectric conversion unit provided below the original platen glass. The scanner 102 may include an auto document feeder (ADF).

The printer (image forming mechanism) 103 includes paper feed cassettes 121A, 121B, and 121C. These paper feed cassettes 121A, 121B, and 121C store media (image forming media) such as sheets to be processed. The media M stored in the paper feed cassettes 121A, 121B, and 121C are conveyed by a conveyance system 123 (to be described later). For example, the paper feed cassettes 121A, 121B, and 121C are detachable from the lower portion of the main body of the digital multi-functional peripheral 100. The paper feed cassettes 121A, 121B, and 121C include paper feed rollers 122A, 122B, and 122C, respectively. The paper feed rollers 122A, 122B, and 122C pick up sheets one by one from the paper feed cassettes 121A, 121B, and 121C, respectively. In this embodiment, one of the paper feed cassettes 121A, 121B, and 121C stores the media M with the plurality of RFID tags manufactured by the above-described medium manufacturing system 1.

The conveyance system (conveyance mechanism) 123 conveys a medium (to be referred to as a sheet hereinafter) in the printer 103. The conveyance system 123 includes a plurality of conveyance rollers 123a to 123d and registration rollers 124. The conveyance system 123 conveys a sheet picked up by the paper feed rollers 122A, 122B, or 122C to the registration rollers 124. The registration rollers 124 convey the sheet to a transfer position at a timing of transferring an image.

A plurality of image forming units 125 (125Y, 125M, 125C, and 125K) form images of respective colors (yellow, magenta, cyan, and black). An exposure apparatus 126 forms electrostatic latent images as images developed with the respective colors on image carriers in the image forming units 125 (125Y, 125M, 125C, and 125K). The exposure apparatus 126 forms each electrostatic latent image on the image carrier by scanning the image carrier by light emitted in accordance with image data. For example, the exposure apparatus 126 scans in the main scanning direction by irradiating, via a rotated polygon mirror, a photosensitive drum serving as the image carrier with light emitted by a light-emitting unit. Furthermore, the irradiation position of light from the exposure apparatus 126 moves in the sub-scanning direction when the photosensitive drum rotates. The position and magnification of an image formed by each image forming unit 125 are adjusted by controlling the exposure apparatus 126.

Each image forming unit 125 (125Y, 125M, 125C, or 125K) develops the electrostatic latent image with toner of the corresponding color (yellow, magenta, cyan, or black) on the corresponding image carrier. An intermediate transfer belt 127 is an intermediate transfer member. Each image forming unit 125 transfers (primarily transfers), onto the intermediate transfer belt 127, the toner image of the corresponding color developed with the toner of the corresponding color on the corresponding carrier.

The intermediate transfer belt 127 holds the transferred toner image and transfers it to a secondary transfer position. The secondary transfer position is a position where the toner image on the intermediate transfer belt 127 is transferred to a sheet. The secondary transfer position is a position where a support roller 128a and a secondary transfer roller 128b face each other. The support roller 128a and the secondary transfer roller 128b form a transfer unit 128. The registration rollers 124 convey the sheet to the secondary transfer position in synchronism with the toner image on the intermediate transfer belt 127. The transfer unit 128 transfers the toner image held on the intermediate transfer belt 127 to the sheet at the secondary transfer position.

For example, when forming a color image, the respective image forming units 125Y, 125M, 125C, and 125K transfer, onto the intermediate transfer belt 127, the toner images developed with the toners of the respective colors (yellow, magenta, cyan, and black) so as to overlap each other. The intermediate transfer belt 127 holds the color image in which the toner images of the respective colors overlap each other. The transfer unit 128 transfers the color image with the toners of the plurality of colors on the intermediate transfer belt 127 to the sheet at the secondary transfer position. The registration rollers 124 convey the sheet to the secondary transfer position in synchronism with the toner images on the intermediate transfer belt 127. This transfers the color image to the sheet.

The transfer unit 128 supplies the sheet with the toner images transferred thereon to a fixing unit 129. The fixing unit 129 fixes the toner images to the sheet. The fixing unit 129 includes a heating unit 129a, a heat roller 129b, and a pressurizing roller 129c. The heating unit 129a heats the heat roller 129b. The heat roller 129b and the pressurizing roller 129c perform fixing processing of heating, under pressure, the sheet onto which the toner images are transferred by the transfer unit 128. The heat roller 129b and the pressurizing roller 129c in the fixing unit 129 transfer, to the conveyance rollers 123d, the sheet having undergone the fixing processing. The conveyance rollers 123d convey the sheet from the fixing unit 129 to a discharge unit 130.

The operation panel 104 is a user interface. The operation panel 104 displays a guidance and accepts input of an operation button or an icon. For example, the user inputs setting information to the operation panel 104. The operation panel 104 includes a display unit (display), a touch panel, and a plurality of operation buttons. For example, in the operation panel 104, the touch panel is provided on the display screen of the display unit. The touch panel detects a portion where the user touches on the display screen of the display unit.

The tag reader/writer 106 communicates with the RFID tag (inlay) 32 provided on the medium M. The tag reader/writer 106 is a reader/writer that writes data in the RFID tag and reads data written in the RFID tag. The tag reader/writer 106 is installed in the digital multi-functional peripheral 100 so as to communicate with the RFID tag provided on the medium M conveyed by the conveyance system 123 in the printer 103.

The tag reader/writer 106 writes data in the RFID tag provided on the medium M at a predetermined write position (writable region) in a conveyance path of the medium M by the conveyance system 123. If the medium M conveyed by the conveyance system 123 includes a plurality of RFID tags, the tag reader/writer 106 writes data when each RFID tag passes through the write position. This allows the tag reader/writer 106 to write different data in the plurality of RFID tags of the medium M.

In addition, the tag reader/writer 106 reads data from each RFID tag provided on the medium M at a predetermined read position (readable region) in the conveyance path of the medium M by the conveyance system 123. If the medium M conveyed by the conveyance system 123 includes a plurality of RFID tags, the tag reader/writer 106 reads data when each RFID tag passes through the read position. This allows the tag reader/writer 106 to read the data from the plurality of RFID tags of the medium M.

Note that in the example of the configuration shown in FIG. 6, the tag reader/writer 106 communicates with the RFID tag of the medium M at a position before a position where an image is transferred. The tag reader/writer 106 is configured to write data in each RFID tag of the medium M conveyed by the conveyance system 123, and read data from each RFID tag of the medium M after the write. The tag reader/writer 106 may be installed at any write position in the conveyance path of the medium M by the conveyance system 123. The tag reader/writer 106 may be an external device detachable from an interface provided in the digital multi-functional peripheral 100.

The configuration of a control system in the digital multi-functional peripheral 100 having the above-described configuration will be described next.

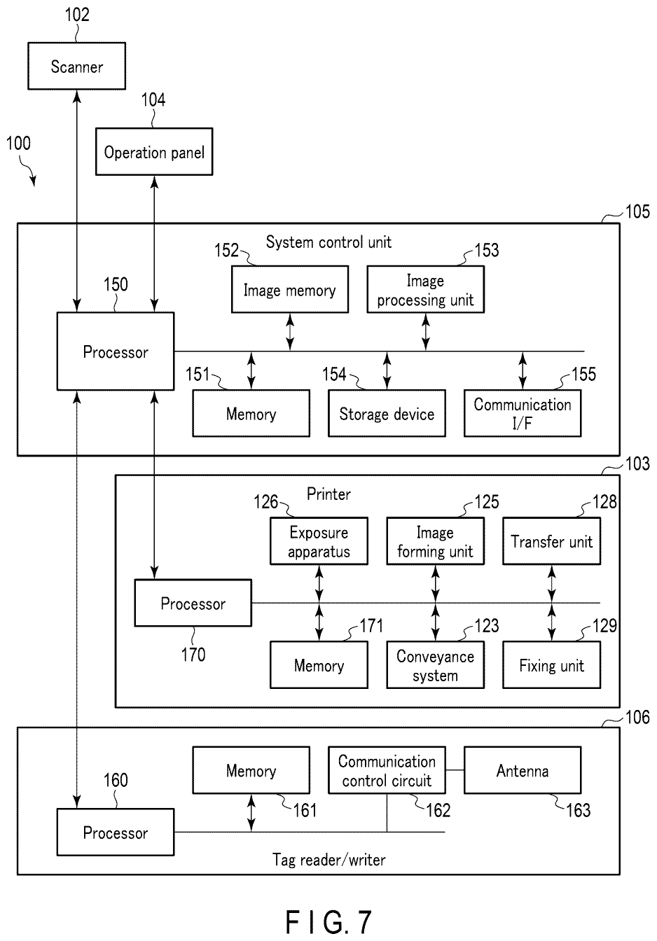

FIG. 7 is a block diagram for explaining an example of the configuration of the control system in the digital multi-functional peripheral 100 having a function of processing the medium M manufactured by the medium manufacturing system 1 according to the embodiment.

The digital multi-functional peripheral 100 includes a system control unit 105 that controls the entire apparatus. The system control unit 105 is connected to the scanner 102, the printer 103, the operation panel 104, and the tag reader/writer 106. In the example of the configuration shown in FIG. 7, the system control unit 105 includes a processor 150, a memory 151, an image memory 152, an image processing unit 153, a storage device 154, and a communication interface (I/F) 155.

The processor 150 is connected to, via interfaces, the scanner 102, the processor 170 of the printer 103, the operation panel 104, and a processor 160 of the tag reader/writer 106. The processor 150 implements various processing functions by executing programs stored in the memory 151 or the storage device 154. For example, the processor 150 outputs operation instructions to the respective units and processes various kinds of information from the respective units by executing the programs stored in the memory 151.

The memory 151 includes a memory such as a RAM (Random Access Memory), a ROM (Read Only Memory), and an NVM. The RAM functions as a working memory or a buffer memory. The ROM is a non-rewritable non-volatile memory. The ROM functions as a program memory. The NVM is a rewritable non-volatile memory. The NVM stores setting data and the like.

The image memory 152 stores image data. For example, the image memory 152 functions as a page memory for deploying image data to be processed.

The image processing unit 153 processes image data. The image processing unit 153 outputs, for example, image data obtained by performing image processing such as correction, compression, decompression for the input image data. The image processing unit 153 includes a processor for image processing. The processor for image processing in the image processing unit 153 may have a variable operating frequency (operation speed).

The storage device 154 stores control data, control programs, and data such as setting information. The storage device 154 is formed by a rewritable non-volatile memory. For example, the storage device 154 is formed by a storage device such as an HDD (Hard Disc Drive) or an SSD (Solid State Drive).

The communication I/F 155 is an interface for performing data communication with an external apparatus. For example, the communication I/F 155 is an interface that communicates with an external apparatus as an output destination to which an image scanned by a network scan function is output. Furthermore, the communication I/F 155 is an interface that receives a print image and a print instruction from an external apparatus by a network print function. The communication I/F 155 includes an interface for transmitting, to a FAX transmission destination, FAX data generated from a scanned image by a FAX function. The communication I/F 155 may be an interface for communicating with an external apparatus (server or the like) that collects values of a scan counter and a print counter, and the like.

Next, an example of the configuration of a control system in the printer 103 will be described.

As shown in FIG. 7, the printer 103 includes a processor 170, a memory 171, the conveyance system 123, the image forming unit 125, the exposure apparatus 126, the transfer unit 128, and the fixing unit 129.

The processor 170 implements various processes by executing programs stored in the memory 171. For example, the processor 170 controls the operation of each unit in the printer 103 by executing the program, and monitors the operation status of each unit. The processor 170 is connected to the processor 150 of the system control unit 105 via an interface. The processor 170 executes print processing or the like in accordance with an operation instruction from the system control unit 105.

The memory 171 includes a memory such as a RAM (Random Access Memory), a ROM (Read Only Memory), and a data memory. The RAM functions as a working memory or a buffer memory. The ROM is a non-rewritable non-volatile memory. The ROM functions as a program memory. The data memory is a rewritable non-volatile memory.

The conveyance system 123 conveys the medium M in the printer 103 under the control of the processor 170. That is, the conveyance system 123 conveys the medium M by driving the conveyance rollers of the respective units in accordance with an operation instruction from the processor 170.

The exposure apparatus 126 irradiates each of the photosensitive drums of the image forming units 125 with light (laser beam) for forming an electrostatic latent image in accordance with an operation instruction from the processor 170. The processor 170 adjusts a print position, a magnification, and the like by controlling the irradiation position of the laser beam on each photosensitive drum by the exposure apparatus 126. Each image forming unit 125 develops, with the toner of the corresponding color, the electrostatic latent image formed on the corresponding photosensitive drum in accordance with an operation instruction from the processor 170. In addition, each image forming unit 125 transfers (primarily transfers) the toner formed on the corresponding photosensitive drum to the intermediate transfer belt.

The transfer unit 128 transfers (secondarily transfers), onto the medium M, the toner image transferred to the intermediate transfer belt 127 in accordance with an operation instruction from the processor 170. The fixing unit 129 drives the heat roller 129b and the pressurizing roller 129c in accordance with an operation instruction from the processor 170. Furthermore, the heating unit 129a of the fixing unit 129 controls the surface temperature of the heat roller 129b to a desired fixing temperature under the control of the processor 170. The fixing unit 129 fixes, to the medium M, the toner image transferred to the medium M while the temperature is controlled to the fixing temperature.

Next, an example of the configuration of a control system in the tag reader/writer 106 will be described.

As shown in FIG. 7, the tag reader/writer 106 includes the processor 160, a memory 161, a communication control circuit 162, and an antenna 163.

The processor 160 implements various processes by executing programs stored in the memory 161. For example, the processor 160 controls the operation of each unit in the tag reader/writer 106 by executing the program. The processor 160 is connected to the processor 150 of the system control unit 105 via an interface. The processor 160 executes transmission of a command with respect to the RFID tag, processing of a response, and the like in accordance with an operation instruction from the system control unit 105.

The memory 161 includes a memory such as a RAM (Random Access Memory), a ROM (Read Only Memory), and a data memory. The RAM functions as a working memory or a buffer memory. The ROM is a non-rewritable non-volatile memory. The ROM functions as a program memory. The data memory is a rewritable non-volatile memory.

The communication control circuit 162 processes signals transmitted/received by the antenna 163. The communication control circuit 162 is connected to the processor 160 and the antenna 163. The communication control circuit 162 includes, for example, a modulation circuit, an amplification circuit, an output setting circuit, and a demodulation circuit.

The antenna 163 transmits/receives radio waves. The antenna 163 is connected to the communication control circuit 162. The antenna 163 transmits, as a radio wave, a signal from the communication control circuit 162. In addition, the antenna 163 supplies, to the communication control circuit 162, a signal received as a radio wave.

For example, the communication control circuit 162 transmits, from the antenna 163, as a radio wave, a signal supplied from the processor 160. The communication control circuit 162 causes the modulation circuit to modulate the signal from the processor 160, causes the amplification circuit to amplify the modulated signal, and outputs the thus obtained signal as a radio wave from the antenna 163. Furthermore, the communication control circuit 162 processes a radio wave received by the antenna 163 and supplies it to the processor 160. The communication control circuit 162 causes the amplification circuit to amplify a radio wave signal received by the antenna 163, then causes the demodulation circuit to demodulate the amplified radio wave signal, and supplies the demodulated signal to the processor 160. The communication control circuit 162 also has a function of controlling the intensity of the radio wave output from the antenna 163. The communication control circuit 162 outputs the radio wave at an output level that is set in the amplification circuit by the output setting circuit in accordance with a control command from the processor 160.

Next, the relationship between the medium M manufactured by the medium manufacturing system 1 according to the embodiment and the digital multi-functional peripheral 100 serving as an image forming apparatus will be described.

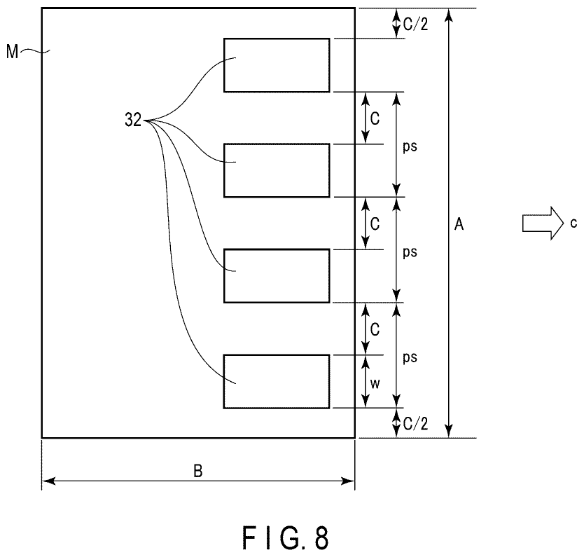

FIG. 8 is a view showing a conveyance state in which the medium M manufactured by the medium manufacturing system 1 is conveyed by the conveyance system 123 of the digital multi-functional peripheral 100 according to the embodiment.

Assume that the medium M shown in FIG. 8 is manufactured by cutting the medium base material 11 shown in FIG. 5 along the dotted lines. Therefore, on the medium M, the four inlays (RFID tags) 32 are arranged at equal intervals with the pasting pitch ps in the direction of the size A and the distance from the leading edge or the trailing edge to the RFID tag 32 is C(=ps−w)/2.

In the example shown in FIG. 8, assume that the conveyance system 123 of the digital multi-functional peripheral 100 conveys the medium M in a direction of an arrow c. In this case, the tag reader/writer 106 of the digital multi-functional peripheral 100 executes write or read of data in or from each of the four RFID tags 32 arranged in the direction orthogonal to the conveyance direction of the medium M.

With respect to the medium M manufactured by the medium manufacturing system 1, the position of each RFID tag on the medium M can be specified based on the size and the number of RFID tags. This allows the digital multi-functional peripheral 100 to optimize communication settings in each RFID tag on the medium M by the tag reader/writer 106. For example, the tag reader/writer 106 can be set to be able to access each of the RFID tags 32 arranged with the pitch ps in the direction orthogonal to the conveyance direction of the medium M.

Note that the tag reader/writer 106 may be configured to access the RFID tags in the first half in the conveyance direction of the medium M in order to reliably access each RFID tag arranged on the medium M during conveyance in the digital multi-functional peripheral 100. In the example of the arrangement shown in FIG. 8, the medium M is configured to include the RFID tags 32 arranged in the first half in the conveyance direction c.

Next, a method of manufacturing the medium M with the plurality of inlays (RFID tags) 32 by the medium manufacturing system 1 according to the embodiment will be described.

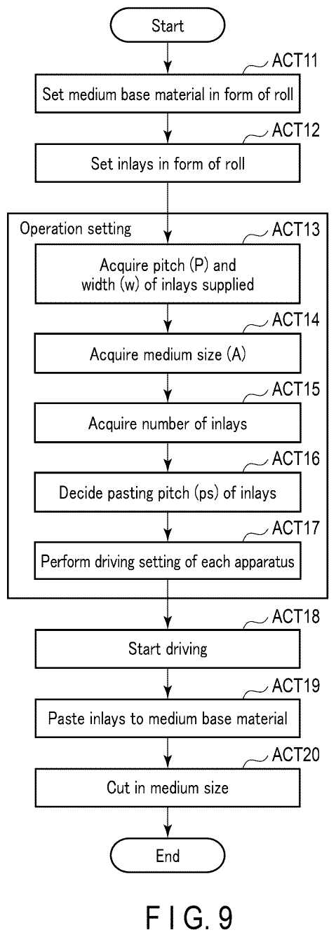

FIG. 9 is a flowchart for explaining the method of manufacturing the medium M with the plurality of inlays (RFID tags) by the medium manufacturing system 1 according to the embodiment.

First, in the medium manufacturing system 1, the medium base material roll 10 is set on the roll shaft 21 of the medium base material conveyance apparatus 20 (ACT11). The medium base material conveyance apparatus 20 is set to be able to convey the medium base material 11 pulled out from the medium base material roll 10 set on the roll shaft 21.

Furthermore, in the medium manufacturing system 1, the inlay supply roll 30 is set on the roll shaft 41 of the inlay conveyance apparatus 40 (ACT12). The inlay conveyance apparatus 40 is set to be able to convey the base material (backing paper) 31 with the inlays 32 arranged thereon pulled out from the inlay supply roll 30 set on the roll shaft 41.

At the start of production (manufacturing) of the medium M, the control apparatus 80 performs operation setting in each apparatus for manufacturing the medium M (ACT13 to ACT17).

The processor 81 of the control apparatus 80 acquires information indicating the pitch p as the arrangement interval of the inlays 32 on the base material 31 supplied from the inlay supply roll 30 and the width w of each inlay 32 (ACT13). For example, the control apparatus 80 acquires information indicating the pitch p and the width w presented as the specifications of the inlay supply roll 30. More specifically, the pitch p of the inlays 32 conveyed by the inlay conveyance apparatus 40 and the width w of each inlay 32 may be input by the operator using the operation unit 87 or may be acquired from an external apparatus connected via an external interface such as the communication unit 85.

The processor 81 of the control apparatus 80 acquires information indicating the size of the medium M to be formed from the medium base material 11 supplied from the medium base material roll 10 (ACT14). For example, the control apparatus 80 acquires information indicating the size B in the direction orthogonal to the conveyance direction specified as the specifications of the medium base material roll 10, and also acquires information indicating the size A in the conveyance direction to cut out the medium M from the medium base material 11. More specifically, the size (A and B) of the medium M may be input by the operator using the operation unit 87 or may be acquired from an external apparatus connected via an external interface such as the communication unit 85.

Furthermore, the processor 81 of the control apparatus 80 acquires information indicating the number of inlays (RFID tags) (the number of pastes) to be arranged on each manufactured medium M (ACT15). For example, the number of inlays to be arranged on the medium M may be designated by the operator using the operation unit 87 of the control apparatus 80. Alternatively, the control apparatus 80 may acquire information indicating the number of inlays on the medium M designated by the operator using an external apparatus that is communicably connected by the communication unit 85.

Upon acquiring the size (A×B) of the medium M and the number (N) of inlays to be arranged on the medium M, the processor 81 of the control apparatus 80 decides the pitch (pasting pitch) ps of the inlays 32 to be pasted to the medium base material 11 (ACT16). Since the processor 81 acquires A and N, a value of ps(=w+C)=A/N is calculated as the pasting pitch ps.

After deciding the pasting pitch ps of the inlays 32 on the medium base material 11, the processor 81 of the control apparatus 80 performs driving setting of each apparatus for pasting the inlays 32 to the medium base material 11 with the pasting pitch ps (ACT17). That is, the processor 81 sets the conveyance speed of the inlays 32 by the inlay conveyance apparatus 40 and the conveyance speed of the medium base material 11 by the medium base material conveyance apparatus 20 so that the inlays 32 are supplied to the medium base material 11 with the pasting pitch ps in the pasting unit 50.

The processor 81 of the control apparatus 80 controls the relative speed between the conveyance speed of the inlays 32 and the conveyance speed of the medium base material 11 in accordance with the difference between the pitches p and ps. For example, the processor 81 may set the conveyance speed of the inlays 32 to a predetermined constant speed, and adjust (control) the conveyance speed of the medium base material 11 in accordance with the pasting pitch ps. Alternatively, the processor 81 may set the conveyance speed of the medium base material 11 to a predetermined constant speed, and adjust (control) the conveyance speed of the inlays 32 in accordance with the pasting pitch ps.

As a practical example, if the conveyance speed of the inlays 32 is set to the predetermined constant speed, the processor 81 calculates the supply interval of the inlays 32 to the pasting unit 50 based on the pitch p of the inlays 32 on the base material (backing paper) 31 and the conveyance speed of the inlays 32. The processor 81 calculates the conveyance speed of the medium base material 11 by the medium base material conveyance apparatus 20 so that the inlays 32 supplied to the pasting unit 50 at the calculated supply intervals are pasted to the medium base material 11 with the pasting pitch ps. In this case, the processor 81 sets the inlay conveyance apparatus 40 to convey the inlays 32 at the predetermined constant speed and sets the medium base material conveyance apparatus 20 to convey the medium base material 11 at the conveyance speed corresponding to the pasting pitch ps.

Furthermore, after deciding the conveyance speed of the medium base material 11, the processor 81 of the control apparatus 80 sets a cutting position (timing) at which the cutting apparatus 60 cuts the medium base material 11 so as to cut the medium base material 11 in the size A of the medium A in the conveyance direction. The processor 81 of the control apparatus 80 sets the cutting apparatus 60 to cut the medium base material 11 at a cutting position set between the inlays (RFID tags) on the medium base material 11.

In the example shown in FIG. 5, the cutting position is the center position between the inlays. In this case, the processor 81 sets the cutting apparatus 60 to start cutting the medium base material 11 at the center position (C/2) between the inlays 32 pasted to the medium base material 11. The cutting apparatus 60 detects the leading edge of the first inlay 32 pasted to the medium base material 11, and starts cutting the medium base material 11 at a position (the center position between the inlays) of a distance C/2 from the leading edge of the first inlay 32.

However, the cutting position set between the inlays 32 pasted to the medium base material 11 may be set at an arbitrary position. All the inlays 32 are arranged on the medium base material 11 at equal intervals with the pasting pitch ps set in accordance with the size A of the medium M and the number of inlays 32. Therefore, the cutting position is not limited to the center position between the inlays and need only be set between the inlays. If the cutting position is set at an arbitrary position between the inlays, the media M cut out in the size A from the medium base material 11 have the same configuration.

When driving setting is performed for the medium base material conveyance apparatus 20, the inlay conveyance apparatus 40, and the cutting apparatus 60, the processor 81 of the control apparatus 80 instructs to start driving of each apparatus (ACT18). After performing driving setting, each apparatus starts driving in accordance with a driving start instruction from the control apparatus 80.

The control unit 25 of the medium base material conveyance apparatus 20 sets the conveyance speed of the medium base material 11 by the medium base material conveyance unit 27 in accordance with a setting instruction from the control apparatus 80 with which communication is performed by the communication unit 26. After the driving setting, the control unit 25 of the medium base material conveyance apparatus 20 causes the medium base material conveyance unit 27 to convey the medium base material 11 pulled out from the medium base material roll 10 at the set conveyance speed in accordance with a driving start instruction from the control apparatus 80.

The control unit 45 of the inlay conveyance apparatus 40 sets the conveyance speed of the inlays 32 by the inlay conveyance unit 47 in accordance with a setting instruction from the control apparatus 80 with which communication is performed by the communication unit 46. After the driving setting, the control unit 45 of the inlay conveyance apparatus 40 causes the inlay conveyance unit 47 to convey the base material 31 with the inlays 32 arranged thereon pulled out from the inlay supply roll 30 at the set conveyance speed in accordance with a driving start instruction from the control apparatus 80.

When the medium base material conveyance apparatus 20 and the inlay conveyance apparatus 40 start driving, the pasting unit 50 pastes, to the medium base material 11, the inlays 32 supplied with the pasting pitch ps (ACT19). The pasting unit 50 sequentially pastes, to the medium base material 11, the inlays 32 peeled off from the base material (backing paper) 31 by the roller 43. As shown in FIG. 5, this creates the medium base material 11 to which the inlays (RFID tags) 32 are pasted with the pasting pitch ps.

The medium base material 11 to which the pasting unit 50 pastes the inlays (RFID tags) 32 with the pasting pitch ps is further conveyed to the cutting apparatus 60 by the medium base material conveyance apparatus 20. As indicated by the dotted lines in FIG. 5, the cutting apparatus 60 cuts, in the size of the medium M in the conveyance direction, the medium base material 11 to which the inlays 32 are pasted (ACT20).

The control unit 65 of the cutting apparatus 60 sets the cutting position (cutting timing) of the medium base material 11 by the cutting unit 67 in accordance with a setting instruction from the control apparatus 80 with which communication is performed by the communication unit 66. After the driving setting, the control unit 65 of the cutting apparatus 60 causes the cutting unit 67 to cut, at the set cutting position, the medium base material 11 conveyed by the medium base material conveyance apparatus 20 in accordance with a driving start instruction from the control apparatus 80. Thus, the media M cut out from the medium base material 11 by the cutting apparatus 60 have the same configuration in which the inlays (RFID tags) 32 the number of which is designated based on the designated size are pasted at equal intervals.

As described above, by the medium manufacturing method according to the embodiment, it is possible to efficiently, sequentially manufacture media (multi-tag media) to which the designated number of RFID tags are pasted while conveying the medium base material and the inlays at conveyance speeds set in accordance with the pasting pitch without performing complicated driving control. On each of the media sequentially manufactured, the RFID tags can be arranged at equal intervals set in accordance with the size of each medium and the number of RFID tags on each medium. As a result, by the medium manufacturing method according to the embodiment, it is possible to easily mass-produce media having the same configuration without waste.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A medium manufacturing method of manufacturing a medium with a plurality of RFID tags, comprising:
deciding a pasting pitch with which a plurality of RFID tags are pasted at equal intervals to a medium base material cut out in a designated size;
supplying, to a pasting position, each RFID tag conveyed from an RFID tag supply roll obtained by holding, in a form of a roll, a base material with a plurality of RFID tags arranged thereon, and
conveying the medium base material so that the RFID tag supplied to the pasting position is pasted with the pasting pitch.

2. The method according to claim 1, wherein the pasting pitch is decided based on a size of one medium in a conveyance direction of the medium base material and the number of RFID tags to be pasted to one medium.

3. The method according to claim 2, wherein the pasting pitch has a value obtained by dividing the size of one medium in the conveyance direction of the medium base material by the number of RFID tags to be pasted to one medium.

4. The method according to claim 2, wherein the pasting pitch is larger than an arrangement interval of the plurality of RFID tags on the base material pulled out and conveyed from the RFID tag supply roll.

5. The method according to claim 1, further comprising cutting, in the designated size, the medium base material to which the plurality of RFID tags are pasted at the pasting positions with the pasting pitch.

6. The method according to claim 5, further comprising setting, as a cutting position, a predetermined position between the RFID tags pasted to the medium base material with the pasting pitch.

7. The method according to claim 6, wherein the cutting position is a center position in an interval between the RFID tags on the medium base material.

8. The method according to claim 1, wherein
a conveyance speed of the RFID tag supplied to the pasting position is set to a predetermined constant speed, and
a conveyance speed of the medium base material is adjusted in accordance with the pasting pitch.

9. The method according to claim 1, wherein
a conveyance speed of the medium base material is set to a predetermined constant speed, and
a conveyance speed of the RFID tag supplied to the pasting position is adjusted in accordance with the pasting pitch.

10. A medium manufacturing system for manufacturing a medium with a plurality of RFID tags, comprising:
an RFID tag conveyance apparatus that supplies, to a pasting position, each RFID tag conveyed from an RFID tag supply roll obtained by holding, in a form of a roll, a base material with a plurality of RFID tags arranged thereon;
a medium base material conveyance apparatus that conveys a medium base material to the pasting position; and
a control apparatus that decides a pasting pitch of the RFID tags on the medium base material for pasting a designated number of RFID tags to a medium of a designated size.

11. The system according to claim 10, wherein the pasting pitch is decided based on a size of one medium in a conveyance direction of the medium base material and the number of RFID tags pasted to one medium.

12. The system according to claim 11, wherein the pasting pitch has a value obtained by dividing the size of the medium in the conveyance direction of the medium base material by the number of pasted RFID tags.

13. The system according to claim 11, wherein the pasting pitch is larger than an arrangement interval of the plurality of RFID tags on the base material pulled out and conveyed from the RFID tag supply roll.

14. The system according to claim 10, further comprising a cutting apparatus that cuts, in a designated size, the medium base material to which the plurality of RFID tags are pasted at the pasting positions with the pasting pitch and which is conveyed by the medium base material conveyance apparatus.

15. The system according to claim 14, wherein the control apparatus sets, in the cutting apparatus, as a cutting position, a predetermined position between the RFID tags pasted to the medium base material with the pasting pitch.

16. The system according to claim 15, wherein
the cutting position is a center position between the RFID tags on the medium base material.

17. The system according to claim 10, wherein the control apparatus sets a conveyance speed of the RFID tag supplied to the pasting position to a predetermined constant speed, and adjusts a conveyance speed of the medium base material in accordance with the pasting pitch.

18. The system according to claim 10, wherein the control apparatus sets a conveyance speed of the medium base material to a predetermined constant speed, and adjusts a conveyance speed of the RFID tag supplied to the pasting position in accordance with the pasting pitch.

19. A non-transitory storage medium storing a program for causing, in an image forming apparatus including a thermal head with a plurality of heating elements arranged in a printing line orthogonal to a conveyance direction of a medium, a head driving unit that heats each heating element in the thermal head, and a processor, the processor to execute:
causing a control apparatus in a medium manufacturing system for manufacturing a medium with a plurality of RFID tags to
decide a pasting pitch with which a plurality of RFID tags are pasted at equal intervals to a medium base material cut out in a designated size,
supply, to a pasting position, each RFID tag conveyed from an RFID tag supply roll obtained by holding, in a form of a roll, a base material with a plurality of RFID tags arranged thereon, and
convey a medium base material so that the RFID tag supplied to the pasting position is pasted with the pasting pitch.

20. The medium according to claim 19, wherein the program causes the processor to execute cutting, in the designated size, the medium base material to which the plurality of RFID tags are pasted at the pasting positions with the pasting pitch.
